(19) United States
(12) Patent Application Publication
(10) Pub. No.: US 2006/0165935 A1
(43) Pub. Date: Jul. 27, 2006

(54) Selectively permeable membrane

(76) Inventors: Anthony D. Studer, Albany, OR (US); Kevin D. Almen, Albany, OR (US); Cary R. Bybee, Whispering Pines, NC (US); David J. Benson, Albany, OR (US); David M. Hagen, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/040,624

(22) Filed: Jan. 21, 2005

(51) Int. Cl. B32B 33/00

(52) U.S. Cl. 428/40.1

(57) ABSTRACT

A multiple-layered membrane includes a gas permeable membrane layer, a printable surface layer having at least one aperture extending therethrough, and a non-contiguous adhesive layer coupling at least a portion of a first side surface of the gas permeable membrane layer to at least a portion of the printable surface layer, such that a part of the first side surface of the gas permeable membrane layer is exposed through the aperture in the printable surface layer.

### BACKGROUND

Imaging devices may include an imaging fluid storage container for supplying ink to a printhead for printing an image on a media. The imaging fluid storage container may include a gas vent to maintain a pressure within the storage container during printing. A mechanical seal may be utilized to seal the gas vent of the imaging device such that imaging fluid may not easily flow through the gas vent during altitude changes, such as during air transport, of the imaging device. The mechanical seal may include vacuum packaging of the entire imaging fluid storage container. The mechanical seal is manually removed by the operator upon first use of the imaging device. It may be desirable to eliminate the time and expense of the mechanical seal thereby reducing packaging costs and set-up time of the imaging device.

### BRIEF DESCRIPTION OF THE DRAWINGS

FIG. 1 is a schematic side view of one embodiment of an imaging device that includes one embodiment of a selectively permeable membrane.

FIG. 2 is a top view of one embodiment of a selectively permeable membrane on an imaging fluid storage container.

FIG. 3 is a cross-sectional side view of one embodiment of a selectively permeable membrane placed over a gas vent.

FIG. 4 is an exploded view of one embodiment of a selectively permeable membrane including multiple layers.

FIG. 5 is an exploded view of another embodiment of a selectively permeable membrane including multiple layers.

### DETAILED DESCRIPTION OF THE DRAWINGS

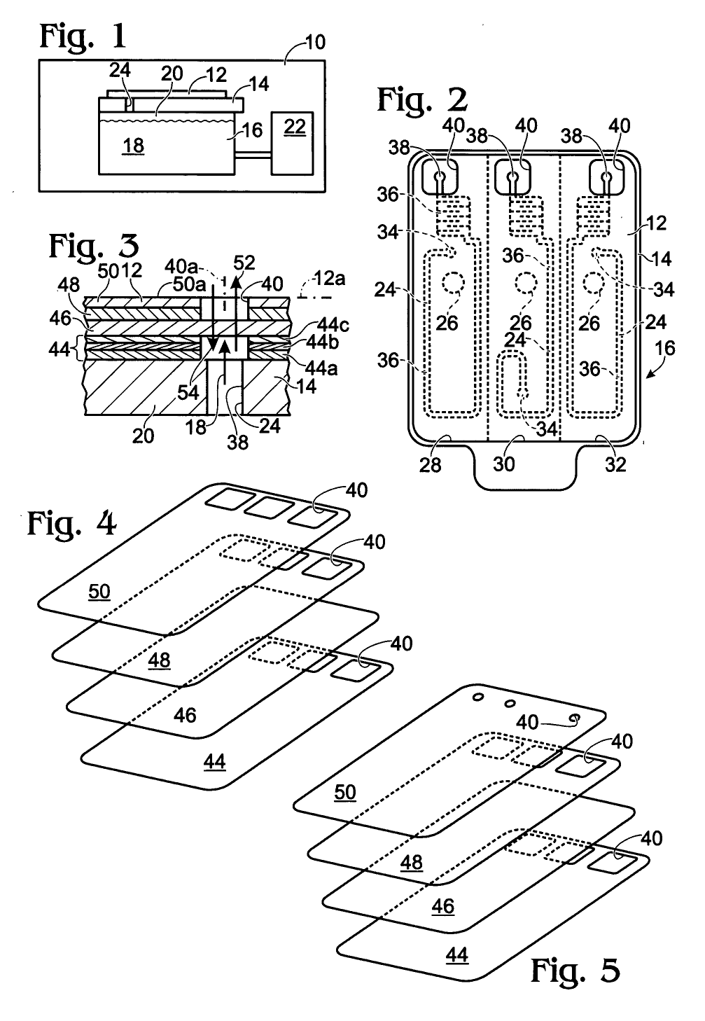

FIG. 1 is a schematic side view of one embodiment of an imaging device 10 that includes one embodiment of a selectively permeable membrane 12 placed on the lid 14 of an imaging fluid storage container 16. The embodiment shown illustrates membrane 12 positioned on an imaging device. However, in other embodiments, membrane may be placed over an opening or vent in any type of device or structure, and is not limited to use on an imaging container or device. Container 16 may include an imaging fluid 18 and a volume of gas 20, such as air, therein. Ink 18 may include any type of imaging fluid, such as ink, and may be in any form, such as free flowing fluid or a fluid contained within the matrix of a bonded polyolefin fiber (BPO), such as a bonder polyester fiber (BPF). Container 16 may be chosen from one of an on-axis imaging fluid container, an off-axis imaging fluid container, a foam-based integrated printhead, or the like. As imaging fluid 18 is depleted from container 16 during printing of the imaging fluid by a printhead 22, gas 20 may comprise a proportionally larger volume of container 16. Accordingly, as imaging fluid 18 is depleted from container 16, gas 20 may move through a gas vent 24 (shown large for ease of illustration) in lid 14 so as to substantially maintain a gas pressure within container 16. Moreover, as imaging device 10 is transported, which may include transport by airplane at altitudes of 14,000 feet for higher, gas 20 may move into or out of container 16 through vent 24 and through selectively permeable membrane 12 so as to substantially maintain a pressure within container 16. However, due to the selectively permeable characteristics of membrane 12, imaging fluid 18 is hindered from flowing through membrane 12 such that imaging fluid 18 does not flow outwardly of container 16 through gas vent 24 and does not contaminate or otherwise damage imaging device 10.

FIG. 2 is a top view of one embodiment of selectively permeable membrane 12 on lid 14 of imaging fluid storage container 16. In the particular embodiment shown, lid 14 includes three fill ports 26 that are utilized to fill container 16 with imaging fluid 18 when membrane 12 is not yet positioned on lid 14. Each of fill ports 26 may correspond to one of three individual chambers 28, 30 and 32, within container 16, wherein each of the three individual chambers may contain a different color imaging fluid, such as cyan, magenta and yellow ink, respectively.

Lid 14 may further include three gas vents 24 that may each define an elongate labyrinth that begins at a gas vent entrance 34 in communication with an interior of container 16, winds along a small-cross sectional area gas vent labyrinth path 36, and which terminates in a gas vent exit aperture 38 that is in communication with the ambient atmosphere. Gas vent exit aperture 38 may be positioned within a window 40 of selectively permeable membrane 12.

Gas exiting container 16 is forced to travel through gas vent entrance 34, along winding labyrinth path 36, and out to the atmosphere through gas vent exit aperture 38. The long exit path 36 facilitates condensation of the gas exiting container 16 such that fluid is hindered from exiting gas vent exit aperture 38. The addition of selectively permeable membrane 12 to lid 14 further enhances the fluid flow inhibiting characteristics of gas vent 24. The size of window 40 may be based on the cross-sectional surface area of aperture 38, the type of fluid 18 contained with container 16, the porosity of membrane 12 (discussed in more detail below), the type of transport that imaging device 18 may be subjected to, or any other variables that may be applicable.

FIG. 3 is a cross-sectional side view of one embodiment of selectively permeable membrane 12 placed over a gas vent 24 of lid 14. Membrane 12 may be configured as a tape and/or a label, and may include printing thereon, as will be discussed below. Membrane 12, in the embodiment shown, includes a first layer 44 positioned on lid 14, a second layer 46 positioned on first layer 44, a third layer 48 positioned on second layer 46, and a fourth layer 50 positioned on third layer 48. First layer 44 includes three sub-layers 44a, 44b and 44c. Window 40 in membrane 12 is shown extending through first layer 44, third layer 48 and fourth layer 50 such that only second layer 46 is exposed within window 40. Window .40 is positioned over gas vent exit aperture 38 such that gas and/or fluid exiting aperture 38 will contact second layer 46 and such that second layer 46 is exposed on its top and bottom sides within window 40. Window 40 may define an aperture within layers 44, 48 and 50 that may be aligned along an axis 40a that may be substantially perpendicular to a plane 12a of said selectively permeable membrane 12 so as to define a window including only second layer 46 therein.

First layer 44 may be an adhesive layer including three sub-layers 44a, 44b and 44c. First and third sub-layers 44a and 44c may be an acrylic, such as an acrylic pressure sensitive adhesive. Second sub-layer 44b may be a tissue layer also known as a carrier, such as Polypropylene. In this embodiment three layers are utilized so that the tissue or carrier layer could be chosen to further minimize the Water Gas Transmission Rate of membrane 12, or a material could be chosen to minimize the Oxygen Transmission Rate if required. Alternatively, layer 44 could be simplified by using a monolayer of adhesive.

Second layer 46 may be a selectively permeable layer, such as a hydrophobic layer or an oleophobic layer and, in particular, may be a layer of polytetrafluoreneethylene (PTFE). Second layer 46 may provide a positive vent gas exchange rate in a range of 0.5 to 1.5 cubic centimeters per minute. Second layer 46 may selectively allow gas to vent therethrough but may hinder imaging fluid 18 from flowing therethrough. Second layer 46 may retain its selective permeability characteristics up to 14,000 feet in elevation, such as during periods of transport of imaging device 18 by air. Second layer 46 may define a porosity range of 0.45 to 1.00 microns so that membrane 12 may be referred to as selectively porous. Second layer 46 may inhibit a flow therethrough of fluids with a surface tension in a range of 20 to 70 Dynes/Cm. These properties allow membrane 12 to selectively inhibit or regulate the flow of fluid therethrough, such that imaging fluid 18 may not seep or flow through gas vent 24, even during periods of high stress, such as during impact, vibration or altitude changes during transport. Moreover, due to the controlled venting of container 16 through membrane 12, more ink than heretofore placed in container 16 may be initially placed within container 16, thereby increasing the imaging run time of imaging device 10 before imaging fluid 18 is depleted. Selectively permeable membrane 12, therefore, including selectively permeable layer 46, may allow gas 52 to vent out of container 16 through membrane 12 at window 40, may allow gas 54 to vent into container 16 through membrane 12 at window 40, and may inhibit imaging fluid 18 from exiting container 16 through membrane 12 at window 40.

Third layer 48 may be an adhesive, such as acrylic used to bond the second layer 46 to the fourth 50.

Fourth layer 50 may be a material such as Oriented Polypropylene and may include an exposed surface 50a that is oxidized by a corona discharge process to provide a printable surface. The corona discharge may oxidize exposed surface 50a by the formation of polar groups on reactive sites, thereby making surface 50a receptive to coatings thereon, such as printing. Accordingly, exposed surface 50a of fourth layer 50 may define a printable surface that may allow marketing, labeling, barcode information or the like to be printed thereon. Additionally, layer 50 may define a water gas transmission rate (WVTR) of 0.1 to 0.14 g/100 sq. in/day@100 Degrees F., 90% RH (wherein this measured value is based on the water gas transmission rate through a sheet of the material without the other layers of the stack being present, i.e., measured when this layer stands alone).

FIG. 4 is an exploded view of one embodiment of selectively permeable membrane 12 including multiple layers 44, 46, 48 and 50. In this embodiment, the three windows 40 (one for each of chamber 28, 30 and 32 of container 16, as shown in FIG. 2) within each of layers 44, 48 and 50 define approximately the same cross-sectional area.

FIG. 5 is an exploded view of another embodiment of selectively permeable membrane 12 including multiple layers 44, 46, 48 and 50. In this embodiment, the three windows 40 in oriented polypropylene layer 50 may define a cross-sectional surface area that is smaller than a cross-sectional surface area, respectively, of the three windows 40 in each of first and second adhesive layers 44 and 48. The smaller size of windows 40 in top layer 50 may allow top layer 50 to provide additional impact protection to oleophobic membrane 46 positioned there below. Moreover, the relatively smaller size of windows 40 in top layer 50 may allow additional regulation of the gas flow rate through permeable membrane layer 46.

Other variations and modifications of the concepts described herein may be utilized and fall within the scope of the claims below.

We claim:

1. A multiple-layered membrane comprising:
a gas permeable membrane layer;
a printable surface layer having at least one aperture extending therethrough; and
a non-contiguous adhesive layer coupling at least a portion of a first side surface of the gas permeable membrane layer to at least a portion of the printable surface layer, such that a part of the first side surface of the gas permeable membrane layer is exposed through the aperture in the printable surface layer.

2. The membrane of claim 1 wherein said gas permeable membrane layer is selected from a group of gas permeable membrane layers comprising an oleophobic membrane layer and a hydrophobic membrane layer.

3. The membrane of claim 2 wherein said gas permeable membrane includes a layer of polytetrafluoreneethylene (PTFE).

4. The membrane of claim 1 further comprising a second non-contiguous adhesive layer coupled to a portion of a second side surface of the gas permeable membrane.

5. The membrane of claim 4 wherein said second non-contiguous adhesive layer includes an acrylic adhesive.

6. The membrane of claim 4 wherein said second non-contiguous adhesive layer includes an acrylic adhesive on a carrier layer.

7. The membrane of claim 1 wherein the gas permeable membrane defines a gas exchange rate in a range of 0.5 to 1.5 cubic centimeters per minute.

8. The membrane of claim 1 wherein the gas permeable membrane defines a porosity range of 0.45 to 1.00 microns.

9. The membrane of claim 1 wherein the gas permeable membrane inhibits a flow therethrough of fluids with a surface tension in a range of 20 to 70 Dynes/Cm.

10. The membrane of claim 1 wherein the gas permeable membrane includes oriented polypropylene.

11. The membrane of claim 1 wherein the gas permeable membrane includes a polypropylene layer that defines a water gas transmission rate (WVTR) of 0.1 to 0.14 g/100 sq. in/day@100 Degrees F., 90% RH, as measured when said polypropylene layer stands alone.

12. The membrane of claim 1 wherein the gas permeable membrane reduces Oxygen transmission through the membrane.

13. The membrane of claim 1 wherein the printable surface layer includes a corona treated printable surface.

14. The membrane of claim 1, wherein the gas permeable membrane is configured as a pressure-sensitive tape.

15. The membrane of claim 1, wherein the gas permeable membrane is configured as a pressure-sensitive label.
